(19) United States
(12) Patent Application Publication
(10) Pub. No.: US 2007/0142657 A1
(43) Pub. Date: Jun. 21, 2007

(54) Process for the preparation of aliphatic primary alcohols and intermediates in such process

(76) Inventors: Georgios Sarakinos, Maastricht (NL); Quirinus Bernardus Broxterman, Munstergeleen (NL)

Correspondence Address: NIXON & VANDERHYE, PC, 901 NORTH GLEBE ROAD, 11TH FLOOR, ARLINGTON, VA, 22203, US

(21) Appl. No.: 10/578,687

(22) PCT Filed: Nov. 17, 2004
(86) PCT No.: PCT/EP04/13149

§ 371 Date: May 9, 2006

(30) Foreign Application Priority Data
Nov. 17, 2003 (EP) 03078563.8

(51) Int. Cl. C07F 7/00

(52) U.S. Cl. 556/466

(57) ABSTRACT

The invention relates to protected unsaturated alcohol with formula (R¹—O)ₘPG, wherein R¹ represents a linear, straight-chain aliphatic hydrocarbon group containing one or more double bonds and having 26-30 C-atoms, m is 1 or 2 and PG, forming an ether group in combination with the —O— of the former primary alcohol, represents a protecting group chosen from the group of substituted methyl ethers, substituted ethyl ethers, (substituted) benzyl ethers and (substituted) silyl ethers with at least one substituent on the Si-atom being not a methyl group, in case m=1; and a diol protecting group in case m=2; A protected saturated alcohol with formula (R²—O—)ₘPG, herein R² represents a linear straight-chain alkyl group with 26-30 C-atoms and PG and m are as defined above; unsaturated alcohols with formula R¹OH wherein R¹ represents a linear, straight-chain aliphatic hydrocarbon group containing one, two or three double bonds and having 27 C-atoms, a linear, straight-chain aliphatic hydrocarbon group containing one or more double bonds and having 28 C-atoms with the proviso that when R¹ has one double bond which is between C₁₈ and C₁₉ or between C₁₉ and C₂₀, R¹OH has the E-configuration, or a linear, straight-chain aliphatic hydrocarbon group containing two or three double bonds and having 26-29 C-atoms. The invention further relates to processes for the preparation of such protected unsaturated alcohols via an organometallic cross coupling reaction, a Wittig reaction via Olefin Cross Metathesis.

### FIELD OF THE INVENTION

The present invention relates to High-molecular-weight aliphatic saturated primary alcohols, for instance with 20-40 C-atoms are useful products for use for instance in food or pharmaceutical products. For instance policosanol is a rrixture of high-molecular-weight aliphatic primary alcohols with as its main component octacosanol (C28). It is used for instance for improvement of serum lipid profiles, which makes it an interesting compound for the prevention and treatment of cardiovascular diseases, and as a cholesterol-lowering additive in foods.

These alcohols, often mixtures thereof, are normally isolated from natural sources, for instance bees wax or plant sources such as sugar cane wax, rice bran wax and birch bark. A disadvantage of these processes is that the isolation is difficult and tedious, and therefore, expensive. Moreover it is difficult—if so desired—to obtain any given compound in pure form from the mixture. Also if a specific mixture of compounds is desired because this is advantageous for the biologic activity, such specific mixture is difficult to obtain.

A synthetic method therefore would be highly desirable. A number of synthetic methods are described in the literature. For instance in WO-A-02/059101 a synthetic route for the preparation of high-molecular-weight linear straight-chain primary alcohols starting from cyclotetradecanone is disclosed. After enamine formation with a cyclic secondary amine, a ring expansion is achieved by reaction with an activated alkanoic acid. The ring is opened in a further transformation and after two more steps the final alcohol is obtained. The synthesis is a 5-step sequence and moreover comprises a.o. a metal hydride reaction which is not attractive on commercial scale from a viewpoint of safety and costs.

In JP 61159591, an electrolytic Kolbe cross-coupling of two different long-chain carboxylic acids is described. An intrinsic element of such cross-coupling is that it leads to a mixture of products. It results in the formation of a 1-alkanoic acid methyl ester that is afterwards reduced to the 1-alkanol. Such processes, however, are commercially less attractive because they require specialized equipment, lead at best to moderate yields and require significant purification procedures.

The present invention now makes it possible to prepare high-molecular-weight aliphatic linear, straight-chain primary alcohols in a simple synthetic process.

Of course, also specific mixtures of high molecular-weight aliphatic linear straight-chain primary alcohols can easily be prepared e.g. by the choice of the starting materials.

Key intermediates in such processes are unsaturated protected primary alcohols with formula (1)
(R¹—O—)ₘPG (1)

wherein R¹ represents a linear, straight-chain aliphatic hydrocarbon group with one or more, preferably 1-4, double bonds having 26-30 C-atoms, m is 1 or 2 and PG, forming an ether group in combination with the —O— of the former primary alcohol, represents a protecting group chosen from the group of substituted methyl, substituted ethyl, (substituted) benzyl and (substituted) silyl groups, with at least one substituent on the Si-atom being not a methyl group, if m=1; or a protecting group for dihydroxy functionalities (diol protecting group) if m=2. The terms (substituted) methyl, (substituted) ethyl, (substituted) benzyl and (substituted) silyl have the meanings as described by T. W. Greene & PGM. Wuts in Protecting Groups in Organic Synthesis, 3^{rd} Edition, Wiley & Sons; New York, 1999, pp 17-19 and pp 27-148; protecting groups for compounds with dihydroxy functionality are for instance described on pp 201-241 of this same reference (Greene & Wuts). Examples of suitable substituted methyl protective groups are methoxymethyl, methylthiomethyl, benzyloxymethyl, p-methoxytetrahydropyranyl, methoxybenzyloxymethyl, p-nitrobenzyloxymethyl, o-nitrobenzyloxymethyl, guaiacolmethyl, t-butoxymethyl, t-butyidimethylsiloxymethyl, 2-methoxyethoxymethyl, 2,2,2-trichloroethoxymethyl, 2-(trimethylsilyl)ethoxymethyl, methoxymethyl, tetrahydrophyranyl, 1-methoxycyclohexyl, 1,4-dioxan-2-yl and/or tetrahydrofuranyl. Examples of suitable substituted ethyl protecting groups are 1-ethoxyethyl, 1-(2-chloroethoxy)ethyl, 1-methyl-1-methoxyethyl, 1-methyl-1-benzyloxyethyl, 1-methyl-1-phenoxyethyl, 2,2,2-trichloroethyl, 2-(benzylthio)ethyl, p-chlorophenyl, t-butyl, allyl and/or propargyl. Examples of suitable substituted benzyl protecting groups are benzyl, p-methoxybenzyl, p-nitrobenzyl, 2,6-dichlorobenzyl, p-phenylbenzyl, 2,6-difluorobenzyl, 2-picolyl, 4-picolyl, p,p′-dinitrobenzhydryl, triphenylmethyl, and/or 1,3-benzodithiolan-2-yl. Suitable substituted silyl protecting groups have sufficient stability under the reaction conditions under which they are formed and/or the work up thereof, of which at least one of the substituents on the Si-atoms is not a methyl group, for example triisopropylsilyl, t-butyidimethylsilyl, t-butyldiphenylsilyl, t-butylmethoxyphenylsilyl triethylsilyl, triisopropylsilyl, dimethylisopropylsilyl, diethylisopropylsilyl, dimethylthexylsilyl, t-butyldimethylsilyl, t-butyidiphenylsilyl, triphenylsilyl, diphenylmethylsilyl, di-t-butylmethylsilyl, t-butoxydiphenylsilyl and/or t-butylmethoxyphenylsilyl. Examples of suitable diol protecting groups are methylene, ethylidene, t-butylmethylidene, 1-t-butylethylidene, 1-phenylethylidene, 1-(4-methoxyphenyl)ethylidene, 2,2,2-trichloroethylidene, isopropyliden, cyclopentylidene, cyclohexylidene, benzylidene, mesitylene, benzophenone, methoxymethylene, ethoxymethylene, di-t-butylsilylene.

The double bonds in R¹ may relate to Z-isomers, E-isomers or mixtures thereof. Preferably R¹ has one double bond. More double bonds are allowed but have no beneficial effects. Basically the choice of the number of double bonds in R¹ will depend largely on the availability of the key raw materials.

In one embodiment the key intermediates with formula (1) are prepared via a so-called organometallic cross-coupling reaction. Such organometallic cross-coupling reactions appeared to work very well, even in the presence of other functional groups.

One example of such an organometallic cross-coupling reaction is schematically as given below.

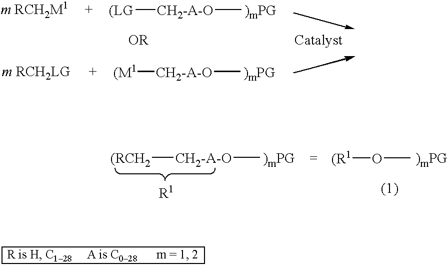

It represents the-reaction of a straight-chain nucleophilic organometallic reagent of formula RCH₂M¹ with a linear, straight-chain electrophile of formula (LG-CH₂-A-O—)ₘPG (or a linear, straight-chain electrophile of formula RCH₂LG with a nucleophilic organometallic reagent of formula (M¹-CH₂-A-O—)ₘPG), wherein m=1 or 2, R is H or a linear straight-chain aliphatic hydrocarbon group with 1-28 C-atoms, optionally with one or more double bonds, M¹ represents Li, Na, K, BZ₂ (wherein Z=OH, an alkyl or alkoxy group, for instance an alkyl or alkoxy group with 1-10 C-atoms, or the 2 Z-groups together may form a 2-7 membered hydrocarbon ring with for instance 2-20 C-atoms, for instance 9-BBN), MgX (wherein X=halogen, for instance Cl, Br, I), ZnX (wherein X=halogen, for instance Cl, Br, I, or CH₂Si(CH₃)₃), MnX (wherein X=halogen, for instance Cl, Br, I), A is a C₀₋₂₈ linear, straight-chain aliphatic hydrocarbon group, LG represents a leaving group (as, for instance, described in D. S. Kemp & F. Vellaccio, Organic Chemistry, Worth: New York, 1980; pp 99-102, 143-144, 179-180, for example F, Cl, Br, I, OSO₂Ar (Ar represents an aryl group), OMs (OMs represents a mesylate group), OTf (OTf represents a triflate group), OP(O)(OR¹¹)₂ (R¹ is an alkyl group, preferably an alkyl group with 1-5 C-atoms), PG is as described above, to produce a linear, straight-chain protected unsaturated alcohol of formula (R¹—O—)ₘG. The reaction preferably is carried out in the presence of a transition metal catalyst, which may be in the form of a neutral or cationic metal complex ML¹ₐL²_{b}X, an anionic complex Qd[ML¹ₐL²_{b}X_{c}]ₑ, a soluble transition metal nanocluster, or as heterogeneous catalyst wherein the metal in the zero oxidation state is deposited in the form of microcrystalline material on a solid carrier, wherein M can be any transition metal known to catalyze such coupling reactions, for instance Mn, Fe, Cu, Ni or Pd. L¹ and L² are ligands (for instance optionally substituted phosphines and bisphosphines such as triphenylphosphine, bis-diphenylphosphinopropane, 1,1′-diphosphaferrocene (dppf), phosphites or bisphosphites, PN ligands in which there is both a coordinating P atom and a N atom present, N-N ligands such as phenanthrolines), X is an anion which may be a halide, a carboxylate or a composite anion such as BF₄⁻ or PF₆⁻, Q is a cation for instance an alkaline metal ion (for instance sodium, potassium) or a tetraalkylammonium salt, a, b, c, d and e are integers from 0-5. The clusters contain from 2 to many thousands of metal atoms and may carry ligands or anions on the outer rim. Suitable carrier materials for heterogenous catalysts are, for instance, carbon black, silica, aluminum oxide.

Particularly when M¹ represents an alkali metal, e.g. Li, Na or K, a metal catalyst is not particularly preferred. Either R or A may be saturated (contain no double bonds) but not both. In the product of formula (1), R¹ (is RCH₂—CH₂A) is a C₂₆₋₃₀ linear, straight-chain hydrocarbon group containing at least one double bond and PG is as above. The reaction preferably is performed under an inert atmosphere (e.g. dry nitrogen or dry argon).

In a preferred embodiment of this organometallic coupling, an alkyl magnesium halide, most preferably an alkyl magnesium chloride or bromide (for instance an amount of 1 to 5 equivalents, preferably 1-2 equivalents) is reacted with 1 equivalent of an alkyl halide or alkyl arylsulfonate, alkyl mesylate or alkyl triflate, most preferably with an alkyl fluoride, alkyl chloride, alkyl bromide, alkyl mesylate or alkyl tosylate in the presence of a transition metal catalyst; as for instance described in Terao, J.; Watanabe, H.; Ikumi, A.;

Kuniyasu, H.; Kambe, N. J. Am. Chem. Soc. 2002, 124, 4222-4223, and Terao, J.; Ikumi, A.; Kuniyasu, H.; Kambe, N. J. Am. Chem. Soc. 2003, 125, 5646-5647. Preferably the reaction is carried out in the presence of a solvent. Suitable solvents are for instance ethyl ether, tetrahydrofuran (THF), i-propyl ether di-n-propyl ether, dimethoxyethane (DME) or methyl t-butyl ether or mixtures of these solvents with a dipolar aprotic solvent such as NMP, DMF or DMA (dimethylacetamide) in any proportion, most preferably THF, and the concentration of each of the reactants is preferably between 0.2 and 3 molar. The transition metal catalyst is based on a transition metal M chosen preferably from Mn, Fe, Cu, Ni, Pd. They can be in the form of pre-formed complexes or made in situ from a catalyst precursor and one or more ligands. If desired an activator (for instance a base, such as an alkoxide, or a reducing agent, such as NaBH₄)- may be added to these complexes. Suitable sources of catalyst precursors are for instance precursors of Cu^{I} (for example CuCl, Cul, CuOTf), Cu^{II} (for example CuCl₂, Li₂CuCl₄), Ni⁰ (for example Ni(COD)₂), Ni^{II} (for example NiCl₂, Ni(acac)₂, NiBr₂), or Pd^{II} (for example PdCl₂, Pd(OAc)₂, Pd₂(dba)₃), Mn^{III} (for example MnCl₃, Mn(acac)₃) or Fe^{III} (for example Fe(acac)₃). Preformed catalysts can also be used, for example (PPh₃)₂NiCl₂, (dppp)NiCl₂ or (dppf)NiCl₂. The amount of catalyst that is used is calculated with respect to the electrophile and is preferably lower than 0.05 equivalents, more preferably between 0.001 and 0.03 equivalents calculated with respect to the electrophile. Preferably less than 4 equivalents of each ligand with respect to the amount of metal M are used. Optionally, the reaction is run in the presence of a 1,3-diene, for example 1,3-butadiene, isoprene or 2,3-dimethyl-1,3-butadiene, in a relative amount of 0.1 to 2.0 equivalents calculated with respect to the electrophile. The temperature at which the reaction is performed preferably lies between −78 to 80° C., more preferably between −20 and 80° C. The reaction time required is preferably between 1 and 24 hours.

In a second preferred embodiment, the nucleophilic reagent may be of the general structure RCH₂ZnX (wherein for example X=Br,l or CH₂SiMe₃, and R is as above); as for instance described in Jensen, A. E.; Knochel, P. J. Org. Chem. 2002, 67, 79-85. Preferably, an alkylzinc iodide (preferred amount 1.05-1.5 equivalents calculated with respect to the electrophile) is reacted with 1 equivalent of an alkyl bromide or iodide, preferably iodide, optionally in the presence of a tetraalkylammonium halide R³₄NX, wherein each R³, independently, represents an alkyl group, for instance an alkyl group with 1-16 C-atoms and X represents a halogen, for instance Cl, Br or 1, for instance n-Pr₄NI, n-Bu₄NBr, n-Bu₄NI (preferred amount 1-5 equivalents with respect to the alkyl halide), and optionally in the presence of a styrene preferably a mono- or polyfluorinated styrene, such as m-fluorostyrene or p-fluorostyrene (preferred amount 0.05-0.30 equivalents calculated with respect to the electrophile) and a Ni^{II} catalyst, such as NiCl₂, Ni(acac)₂, NiBr₂, (PPh₃)₂NiCl2, (dppp)NiCl₂, in a relative amount between 0.01 and 0.20 equivalents calculated with respect to the electrophile. The reaction preferably is carried out in the presence of a solvent. Suitable solvents that may be used are for instance ethers, NMP, DMF or mixtures thereof. The reaction preferably is run at temperatures between −30 and 25° C. The reaction time required preferably is between 2 and 30 h.

In a third preferred embodiment, the nucleophilic reagent may be of the general structure RCH₂BR⁴₂ (wherein each R⁴ independently represents an aikyl group, for instance an alkyl group with 1-10 C-atoms, or may be part of a ring, for instance as in 9-BBN), RCH₂B(OH)₂ or RCH₂B(OR⁴)₂, wherein R is as. above, as for instance described in Netherton, M. R.; Dai, C.; Neuschültz, K.; Fu, G. C. J. Am. Chem. Soc. 2001, 123,10099-10100, Kirchhoff, J. H.; Dai, C.; Fu, G. C. Angew. Chem. Int. Ed. 2002, 41, 1945-1947,-Kirchhoff, J. H.; Netherton, M. R.; Hills, I. D.; Fu, G. C. J. Am. Chem. Soc. 2002, 124, 13662-13663, and Netherton, M. R.; Fu, G. C. Angew. Chem. Int. Ed. 2002, 41, 3910-3912.

In one embodiment an alkyl-(9-BBN) reagent (preferred amount 1-3 equivalents, calculated with respect to the amount of electrophile), is reacted with for instance an alkyl chloride, bromide or tosylate, preferably a bromide or a tosylate. The reaction is catalyzed by a source of Pd⁰ or Pd^{II}, such as Pd(OAc)₂, PdCl₂, or Pd₂(dba)₃, preferably Pd(OAc)₂, in an amount calculated with respect to the electrophile of 0.01-0.10 equivalents. Addition of a stabilizing ligand for the metal may be beneficial. Suitable examples of such stabilizing ligands are PR⁵₃ (wherein each R⁵ independently represents a, for instance C1-C20, alkyl, aryl, heteroaryl, etc. group, e.g. P(i-Pr)₃, P(t-Bu)₃, PCy₃ (Cy=cyclohexyl), PPh₃, P(2-furyl)₃, P(t-Bu)₂Me), preferably PCy₃. The source of the phosphine ligand may also be the corresponding phosphonium salt (less susceptible to oxidation), such as (HP(t-Bu)₂Me)BF₄. The relative amount of the phosphine may be 0.05-0.20 equivalents calculated with respect to the electrophile, preferably in a molar ratio 2:1 to Pd. In addition as a rule a base is added, for instance a phosphate salt such as Na₃PO₄.H₂O or K3PO₄.H₂O; an alkali metal hydroxide, for instance NaOH, KOH, LiOH or CsOH; or a bulky alkoxide base such as LiOt-Bu, NaOt-Bu or KOt-Bu, in a proportion of 1-4 equivalents calculated with respect to the electrophile. The reaction preferably is carried out in the presence of a solvent. Suitable solvents that can be used are the ethers mentioned above, also dioxane or a bulky alcohol, such as t-amyl alcohol. THF is preferably used as the solvent with alkyl-(9-BBN) derivatives and t-amyl alcohol with alkyl boronic acids. In some cases, the addition of one or two equivalents of water with respect to the electrophile may be beneficial. The reaction preferably is run at temperatures between 25 and 100° C. (higher temperatures are preferred for more unreactive alkyl chloride electrophiles).

In another embodiment, the nucleophilic reagent may be of the general structure RCH₂M¹ with M¹=Li, Na, K and R is as above. It is reacted preferably with an alkyl halide or tosylate, preferably an alkyl bromide, iodide or tosylate. A metal catalyst is not particularly preferred in these cases. The stoichiometries of these reactions are as above (for instance an excess organometallic reagent, preferably 1-3 equivalents, most preferably 1-1.5 equivalents). The preferred solvents are here the ethers mentioned above (preferably THF), but also toluene can be suitably used, especially when higher reaction temperatures are required.

In another embodiment the key intermediates with formula (1) are prepared via a Wittig coupling as for instance generally described in M. B. Smith and J. March in March's Advanced Organic Chemistry, Reactions, Mechanisms and Structure, 5ₜₕ Edition, Wiley & Sons: New York, 2001; pp 1231-1237 and in F. A. Carey and R. J. Sundberg in Advanced Organic Chemistry, Part B: Reactions and Synthesis, 3^{rd} Edition, Plenum: New York, 1990: pp. 95-102. Schematically, the Wittig coupling can be represented as follows:

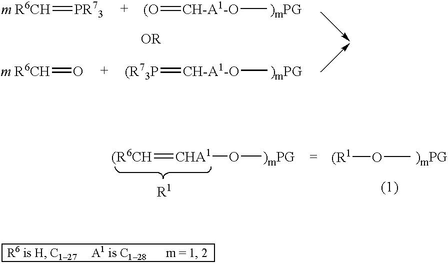

One example of such coupling is the reaction of a linear, straight-chain nucleophilic phosphorous ylide reagent of formula R⁶CH═PR⁷₃ with a linear, straight-chain aldehyde of formula (O=CH—A¹-O—)ₘG (or a linear, straight-chain aldehyde of formula R⁶CH═O with a nucleophilic phosphorous ylide reagent of formula (R⁷₃P═CH-A¹-O—)ₘ-PG), wherein R⁶ is H or C₁₋₂₇ a linear, straight-chain hydrocarbon group, R⁷ is a small alkyl group (for instance with equal to or less than 6 carbons) or aryl, for instance phenyl, group, A¹ is a linear, straight-chain hydrocarbon group with 1-28 C-atoms, PG is as defined above and m is 1 or 2, to produce a linear, straight-chain protected unsaturated alcohol of formula (R¹—O—)ₘG. Both, either or neither R⁶ or A¹ may be saturated (contain no double bonds). In the product of formula (1), R¹ (is R⁶CH═CHA¹) is a linear. straight-chain hydrocarbon group with 26-30 C-atoms containing at least one double bond, and PG is as above. The reaction preferably is performed under an inert atmosphere (e.g. nitrogen or argon).

In a preferred embodiment of this Wittig coupling, an alkyl triphenylphosphoniurm halide, most preferably an alkyl triphenylphosphonium chloride, bromide or iodide is reacted with a base such as an organolithium reagent, for instance n-butyllithium, n-hexyllithium or phenyllithium, or an amide ion, for instance lithium, sodium or potassium amide or hexamethyldisilylamide, or a lithium, sodium or potassium alkoxide, preferably methoxide, ethoxide, t-butoxide or t-amylate, in a stoichiometry of, for instance, 1 to 1.5 equivalents (preferably 1.01-1.1 equivalent) to produce the phosphonium ylide reagent. The Wittig reaction preferably-is carried out in the presence of a solvent. The preferred solvents are ethers, such as ethyl ether, THF, i-propyl ether, di-n-propyl ether, dimethoxyethane (DME) or methyl t-butyl ether; or DMSO, liquid ammonia, toluene, xylenes, ethanol or other low molecular weight alcohols, water, dichloromethane or mixtures thereof, and the concentration of each of the reactants is preferably between 0.2 and 3 molar. The temperature at which the above reaction is performed depends on the ease of formation of the ylide and preferably lies between −78 and +100° C. The reaction time required is preferably between 1 and 24 hours. When the deprotonation step is complete and the phosphonium ylide is formed, the aldehyde (preferably 1-1.5 equivalents) is added without isolation and purification of the phosphonium ylide. The temperature at which the reaction is performed is preferably between 0 and 100° C., more preferably between 20 and 70° C. The reaction time required is preferably between 1 and 24 hours, more preferably between 1 and 8 h.

In a second preferred embodiment of the Wittig coupling, the nucleophilic reagent is formed by treatment of a phosphonate reagent of type R⁶CH₂P(O)(OR¹²)₂ [or ((R¹²O)₂P(O)CH₂-A¹-O)^{m}-PG)] with an appropriate strong base (as defined above in relation to the Wittig chemistry). R⁶, m, A¹ and PG are defined as above. R¹² represents, for instance, a small alkyl group, for instance a methyl or ethyl group. This modification of the original Wittig reaction is called Horner-Emmons, Wadsworth-Emmons or Wittig-Horner reaction. The same product of formula (1) is produced as in the case of the Wittig reaction, but the main advantages are that the reactivity of the phosphonate ylide is higher than that of the trialkylphosphonium ylide and the by-product (R¹²O)₂P(═O)O³¹ is a water-soluble phosphate ester (instead of triphenylphosphine oxide).

In another embodiment the key intermediates with formula (1) are prepared via an Olefin Cross Metathesis (OCM). Schematically, the OCM coupling can be represented as follows:

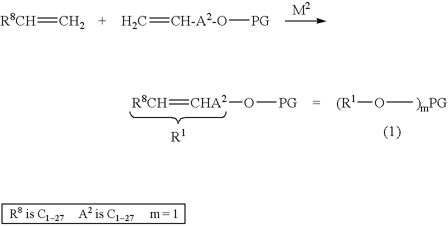

One example of such coupling is the reaction of a linear, straight-chain terminal olefin of formula R⁸CH═CH₂ with a linear, straight-chain terminal olefin of formula H₂C═CH-A²-O-PG, wherein R⁸ is C₁₋₂₇ a linear, straight-chain alkyl group, A² is a linear, straight-chain hydrocarbon group with 1-27 C-atoms, PG is as defined above and M² is an appropriate metal-based catalyst (based on Mo, Ru, W or Ta) bearing ligands (vide infra), to produce a linear, straight-chain protected unsaturated alcohol of formula (1), (R¹—O—)ₘPG, where m is 1. It will be clear that both R⁸ and A² must be saturated (contain no double or triple bonds) or have additional double or triple bonds that do not react under the metathesis reaction conditions. To aid the final purification, the difference in molecular weight of the two olefins preferably is such that the desired product of formula (1) contains at least 5C more or 5C less than the side-product resulting from the homo coupling of the olefin used in excess. In the product of formula (1), R¹ (is R⁸CH═CHA²) is a linear, straight-chain hydrocarbon group with 26-30 C-atoms containing preferably one double bond. The reaction preferably is performed under an inert atmosphere (e.g. dry nitrogen or dry argon).

In a preferred embodiment of this OCM coupling, the two terminal olefins R⁸CH═CH₂ and H₂C═CH-A²-O-PG are mixed in a molar ratio ranging from 10:1 to 1:10 (olefin in excess preferably being the less costly of the two, in order to minimize homo coupling of the most costly olefin). The metal catalyst is then added in an amount of for instance 0.001 to 0.1 equivalents with respect to the limiting olefin. Suitable metathesis catalysts to be used in the process of the present invention are, for example, metal carbene complexes with the general formula R⁹R¹⁰C═M³LₙXₚ wherein M³ represents a metal, for instance Mo, Ru, W, or Ta, preferably Ru, or Mo, R⁹ and R¹⁰ each represent H, an optionally substituted, for instance C1-C20, alkyl, alkenyl, alkynyl, aryl, carboxylate, alkoxy, alkenyloxy, alkynyloxy, aryloxy, alkoxycarbonyl, alkylthio, alkylsulforyl or alkylsulfinyl group. Suitable substituents for the groups in R⁹ and R¹⁰ are for example halogens, alkyl, for instance C1-C5 alkyl, alkoxy, for instance C1-C5 alkoxy or aryl, for instance C6-C10 aryl. The n and p are integers, for instance 0, 1 or 2, each L independently represents a neutral ligand and each X independently represents an anionic ligand. Suitable ligands L are, for example, phosphines (PCy₃, PPh₃, P(p-CF₃-phenyl)₃), THF, N,N′-dimesiyl-imidazol-2-ylidene (mesityl=2,4,6-trimethylphenyl(=Mes)), N,N′-dimesityl-dihydroimidazol-2-ylidene, 4-phenylpyridine. Suitable ligands X are, for example, halogenides (Cl, Br), alkoxides (neopentanolate, 1,1-bis-(trifluoromethyl)ethoxy), aryloxides (in particular disubstituted phenolates (i-Pr, Br), bisnaphtholates), anilides (derived from 2,6-di-isopropylaniline). Such catalysts, e.g. a Schrock catalyst, Blechert modification of the Hoveyda catalyst, first and second generation Grubbs catalyst, are for instance described in A. Fürstner, Angew. Chem. Int. Ed. 2000, 37, 3013-3043, in WO-A-02/00590 and in Connon S. J.; Blechert, S. Angew. Chem. Int. Ed. 2003, 42, 1900-1923. Preferably a catalyst is used wherein M³=Ru, X=Cl, p=2, n=2, L=PCy₃, respectively N,N′-dimesityl-dihydroimidazol-2-ylidene, R⁹=H. R¹⁰=Ph. The OCM reaction may be carried out in the presence of a solvent. The preferred solvents are dry dichloromethane, dry toluene or dry ethers, for example THF or MTBE. The concentration of each of the reactants in the solvent is preferably between 0.5 and 5 molar. The temperature preferably lies between 0 and 100° C., more preferably between 20 and 80° C. The reaction time required is preferably between 1 and 24 hours.

In another preferred embodiment, Ru-based metal catalysts may be immobilized on polymer supports. The structures of these catalysts are very similar to the ones described above. More details may be found in p.p. 1918-1920 of the review of Blechert, S. Angew. Chem. Int. Ed. 2003, 42, 1900-1923, cited above, as well as in the pertinent references.

The protected unsaturated alcohols with formula (1) or mixtures thereof, may subsequently be subjected to reduction and/or deprotection.

The protected unsaturated alcohols with formula (1) or mixtures thereof can be converted into the corresponding (mixtures of) unprotected unsaturated alcohols with formula R¹OH using methods commonly known in the art. Compounds with formula R¹OH, or mixtures of such compounds, wherein R¹ represents a linear straight-chain aliphatic hydrocarbon group with one double bond and having 27 C-atoms, and the compounds with formula R¹OH, or mixtures of compounds, wherein R¹ represents a linear straight-chain aliphatic hydrocarbon group with one double bond and having 28 C-atoms with the exception of the isomerically pure Z-isomer of R¹OH that contains 1 double bond between C₁₉ and C₂₀, and compounds with formula R¹OH, or mixtures of such compounds, wherein R¹ represents a linear straight-chain aliphatic hydrocarbon group with two or three double bonds and having 26-29 C-atoms, are novel, intermediates. The invention therefore, also relates to such (mixtures of) unsaturated alcohols with formula R¹OH wherein R¹ represents a linear, straight-chain aliphatic hydrocarbon group containing two or more double bonds and having 26-29 C-atoms, R¹ represents a linear, straight-chain aliphatic hydrocarbon group containing one double bond and having 27 C-atoms or R¹ represents a linear straight-chain aliphatic hydrocarbon group containing one double bond and having 28 C-atoms with the proviso that when R¹ has one double bond which is between C₁₈ and C₁₉ or between C₁₉ and C₂₀, R¹OH has the E-configuration (but including mixtures of the E- and Z-isomer of the unsaturated alcohol with formula R¹OH—for instance mixtures containing more than 10%, preferably more than 25%, in particular more than 40%, of the E-isomer calculated with respect to the total amount of E- plus Z-isomer—wherein R¹ represents a linear, straight-chain aliphatic hydrocarbon group containing 28 C-atoms with one double bond between C₁₉ and C₂₀).

The unprotected unsaturated alcohols with formula R¹OH wherein R¹ is a linear, straight-chain aliphatic hydrocarbon group with one or more, preferably 1-4, double bonds having 26-30 C-atoms, as defined above, or mixtures thereof, can subsequently be converted into the desired (mixtures of) alcohols with formula R²OH, wherein R² represents a linear straight-chain alkyl group with 26-30 C-atoms, using methods well known in the art, for instance by hydrogenation.

The most common widely known procedure for reducing double bonds involves hydrogenation in the presence of a sub-stoichiometric amount of an insoluble metal catalyst. This is called heterogeneous catalysis. The temperature is not critical; preferably the temperature is between 0 and 275° C. A wide range of pressures of hydrogen gas can be applied for instance 1-200 bar, preferably 1-50 bar, more preferably 1-5 bar. Of course, instead of hydrogen also a suitable hydrogen donor can be used. Typical catalysts are for instance Ra—Ni, Pd on charcoal, nickel boride, Pt, PtO₂, RhO₂, Ru0₂ and ZnO, preferably Pd on charcoal. The reaction preferably is carried out in the presence of a solvent. A wide variety of solvents can be used, for instance alcohols (methanol, ethanol, propanol, etc) or esters (ethyl acetate, i-propyl acetate, etc).

Another well known reduction procedure involves homogeneous catalysis, wherein the metal-based catalyst is dissolved in the reaction medium. Such catalysts include for instance RhCl(Ph₃P)₃ and RuClH(Ph3)3 Solvents, temperatures and pressures are essentially described as above.

Other possible reduction conditions involve the use of unoxidized metals, such as Na⁰ in for instance EtOH or Li⁰ in for instance ammonia or Zn⁰ in for instance acids. Hydrogen gas is not required in these cases.

Furthermore, double bonds can be reduced by boranes and borohydride reagents, such as BH₃ in THF, disiamylborane in THF, LiBEt₃H, etc.

Commonly employed reduction methods, are for instance described in M. B. Smith and J. March in March's Advanced Organic Chemistry, Reactions, Mechanisms and Structure, 5th Edition, Wiley & Sons: New York, 2001; pp 1002-1008 & 1544-1547.

Alternatively the protected unsaturated alcohols with formula (1) and mixtures thereof first can be converted into the corresponding protected saturated alcohols with formula (2)
(R²—O—)ₘPG (2)

wherein R represents a linear straight-chain alkyl group with 26-30 C-atoms and, PG and m are as defined above, and mixtures thereof.

Such (mixtures of) compounds wherein R² represents a linear straight-chain alkyl group with 26-30 C-atoms and PG is as defined above are novel intermediates. The invention therefore also relates to such novel intermediates.

The reduction can be performed following the same procedures as described above, whereby such reduction method is chosen that does not conflict with the chosen protecting group.

The reduction and deprotection may be performed in separate siteps whether or not with isolation of the intermediate—deprotected or saturated—compound. The reduction and deprotection can also be performed in a 1-pot process, under conditions that both reduction and deprotection occurs, whether after each other or at the same time. As is well known, for certain protecting groups a reduction automatically leads to deprotection. Preferably reduction and deprotection are performed in one operation.

Processes for deprotection are commonly known in the art. The skilled person can easily find a suitable method for his case. Some examples are given below.
(R²—O—)ₘPG→R²—OH

For example:

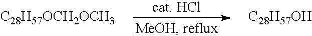

An example of a removal of a common PG from a saturated protected higher (C28) alkanol is shown above. The PG methoxymethyl ether can be cleaved under acidic conditions in methanol, at reflux.
(R¹—O—)ₘPG→R²—OH

For example:

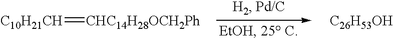

In the above example, a mono-unsaturated protected higher (C26) alkanol is reduced and deprotected in a single chemical operation. The PG is a benzyl ether. The reduction-deprotection conditions involve use of hydrogen gas in ethanol, with Pd on charcoal as a heterogeneous catalyst.
(R¹—O—)ₘPG→R¹—OH

For example:

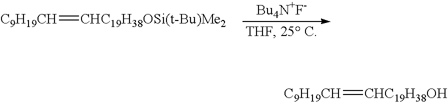

In the final example, a mono-unsaturated protected higher (C30) alkanol is deprotected without affecting the double bond. This can be achieved if, for example, the PG is a t-butyldimethylsilyl group. This PG can be easily removed for instance by fluoride ion in THF at 25° C., originating from, for example, tetrabutylammonium fluoride.

For further details about the above and other protecting groups, see T. W. Greene & P. G. M. Wuts in Protecting Groups in Organic Synthesis, 3^{rd} Edition, Wiley & Sons: New York, 1999; pp 27-148.

The invention will further be elucidated by the following example, without, however, being restricted thereby.

### EXAMPLE 1

Below the experiment is shown schematically 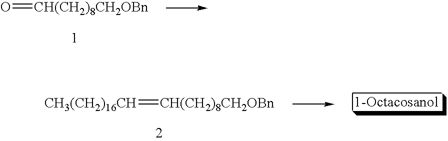
Synthesis of 10-Benzyloxy-Decanal 1.

As described by Shioiri et al. (Tetrahedron 1998, 54, 15701-15710) from 1,10-decanediol, via the 10-Benzyloxy-decan-1-ol.

Wittig Reaction to 2.

To a stirred suspension of octadecyl triphenylphosphonium bromide salt (1.68 mmol) in THF (10 mL) at −10° C. under a nitrogen atmosphere, a solution of n-BuLi (1.6 M in hexane, 1.4 mL, 2.24 mmol) was added over a period of 10 min, keeping the temperature between −10 and −5° C. The bright orange, heterogeneous solution of the resulting phosphonium ylide was stirred for 1 h at −5° C. and then 10-benzyloxy-decanal (1.45 mmol) was added as a solution in THF (1.15 mL) during a period of 20 min. The temperature was allowed to rise to 20° C. over a period of two hours, and the reaction was stirred at 20° C. for another 3 h. It was then quenched with water (5 mL), most of the THF was removed in vacuo (20 mbar, 50° C.) and more water was added (10 mL). The products were extracted into petroleum benzene (3×30 mL) and the combined organic phases were concentrated. The residual crude oil was filtered through a short (1 cm×5 cm) column of silica gel using 10:1 MTESE:petroleum benzene as eluent. The first fractions contained the Wittig product and they were pooled. After removal of the solvents in vacuo (20 mbar, 50° C.) the product was obtained as colorless oil (424 mg, 0.85 mmol, 59% yield based on 10-benzyloxy-decanal), which solidified upon cooling to r.t. ¹H NMR analysis indicated that the purity of the product was >90%.
Reduction-Deprotection

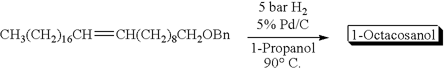

Benzyl octacos-10-enol 2 (390 mg, 0.782 mmol) and 5% Pd/C (34.0 mg, Johnson Matthedy) were suspended in 1-Propanot (6 mL) and with good stirring the mixture was heated to 90° C. under a H₂ pressure of 5 bar for 18 h in an Endeavor apparatus. The reaction mixture was then allowed to cool to 20° C. The solidified solution was diluted with THF (5 mL) and re-dissolved with heating and the catalyst was filtered off through a short plug of decalite. The THF was then removed in vacuo (20 mbar, 60° C.) and MeOH (20 mL) was added and the mixture was stirred at 20° C. for 10 min. The solid product was collected on a fritted funnel under suction, washed with MeOH (20 mL) and allowed to air-dry. 1-Octacosanol was obtained as a colorless solid (257 mg, 0.626 mmol, 80% yield).

Reaction conditions were not optimized.

1. Protected unsaturated alcohol with formula (1)
(R¹—O—)ₘPG (1)
wherein R¹ represents a linear, straight-chain aliphatic hydrocarbon group containing one or more double bonds and having 26-30 C-atoms, m is 1 or 2 and PG represents a protecting group chosen from the group of substituted methyl, substituted ethyl, (substituted) benzyl and (substituted) silyl groups with at least one substituent on the Si-atom being not a methyl group, in case m=1; and a diol protecting group in case m=2.

2. Protected saturated alcohol with formula (2)
(R²—O—)ₘPG (2)
wherein R² represents a linear straight-chain alkyl group with 26-30 C-atoms, m is 1 or 2 and PG represents a protecting group chosen from the group of substituted methyl, substituted ethyl, (substituted) benzyl and (substituted) silyl groups with at least one substituent on the Si-atom being not a methyl group, in case m=1; and a diol protecting group in case m=2.

3. Unsaturated alcohol with formula R¹OH whereinin R¹ represents a linear, straight-chain aliphatic hydrocarbon group containing one, two or three double bonds and having 27 C-atoms.

4. Unsaturated alcohol with formula R¹OH wherein R¹ represents a linear, straight-chain aliphatic hydrocarbon group containing one or more double bonds and having 28 C-atoms with the proviso that when R¹ has one double bond which is between and or between C₁₈ and C₁₉ or between C₁₉ and C₂₀, and R¹OH has the E-configuration.

5. Unsaturated alcohol with formula R¹OH wherein R¹ represents a linear, straight-chain aliphatic hydrocarbon group containing two or three double bonds and having 26-29 C-atoms.

6. Process for the preparation of a protected unsaturated alcohol according to claim 1 via an organometallic cross coupling reaction wherein a linear, straight-chain nucleophilic organometallic reagent of formula RCH₂M¹ is reacted with a linear, straight-chain electrophile of formula (LG-CH₂-A-O—)ₘPG (or a linear, straight-chain electrophile of formula RCH₂-LG with a nucleophilic organometallic reagent of formula M¹CH₂-A-O—)ₘPG), wherein
m=1 or 2
R is H or a linear, straight-chain aliphatic hydrocarbon group with 1-28 C-atoms, optionally with one or more double bonds,
M¹ represents Li, Na, K, BZ₂, wherein each Z independently represents OH, an alkyl or alkoxy group, or the 2 Z-groups together form a hydrocarbon ring, MgX, wherein X=halogen, ZnX, wherein X=halogen or CH₂Si(CH₃)₃ or MnX, wherein X=halogen,
A is a C₀₋₂₈ linear, straight-chain hydrocarbon group,
LG represents a leaving group,
PG represents a protecting group chosen from the group of substituted methyl, substituted ethyl, (substituted) benzyl and (substituted) silyl groups with at least one substituent on the Si-atom being not a methyl group, in case m=1; and a diol protecting group in case m=2.

7. Process according to claim 6, wherein the cross coupling reaction is performed in the presence of a transition metal catalyst and wherein M¹ represents MgX with X is halogen.

8. Process according to claim 7, wherein the nucleophilic organometallic reagent reacts with an alkyl halide, alkyl arylsulfonate or alkyl mesylate.

9. Process for the preparation of a protected unsaturated alcohol according to claim 1 via a Wittig reaction wherein a straight-chain nucleophilic phosphorous ylide reagent of formula R⁶CH═PR⁷₃ is reacted with a straight-chain aldehyde of formula (O═CH-A¹-O—)ₘPG (or a straight-chain aldehyde of formula RCH═O with a nucleophilic phosphorous ylide reagent of formula (R⁷₃P═CH-A¹-O—)ₘ-PG), wherein R⁶ is H, a C₁₋₂₇ linear straight-chain alkyl or alkenyl group, R⁷ is a small alkyl or an aryl group, a linear, straight-chain hydrocarbon group with 1-28 C-atoms, m is 1 or 2 and PG represents a protecting group chosen from the group of substituted methyl, substituted ethyl, (substituted) benzyl and (substituted) silyl groups with at least one substituent on the Si-atom being not a methyl group, in case m=1; and a diol protecting group in case m=2.

10. Process according to claim 9 wherein the nucleophilic reagent is formed by treatment of a phosphonate reagent of type R⁶CH₂P(O)(OR⁷)₂ [or ((R⁷O)₂P(O)CH₂-A¹-Oₘ-PG))] with an appropriate strong base, R⁶ is H, a C₁₋₂₇ linear straight-chain alkyl or alkenyl group, Al is a linear, straight-chain hydrocarbon group with 1-28 C-atoms, m is 1 or 2, PG represents a protecting group chosen from the group of substituted methyl, substituted ethyl, (substituted) benzyl and (substituted) silyl groups with at least one substituent on the Si-atom being not a methyl group, in case m=1; and a diol protecting group in case m=2 and R⁷ represents a small alkyl group.

11. Process for the preparation of a protected unsaturated alcohol according to claim 1 via Olefin Cross Metathesis, wherein a linear, straight-chain terminal olefin of formula R⁸CH═CH₂ is reacted with a linear, straight-chain terminal olefin of formula H₂C═CH-A²-O-PG, wherein R⁸ is C₁₋₂₇ a linear, straight-chain alkyl group, A² is a linear, straight-chain hydrocarbon group with 1-27 C-atoms, m is 1 or 2 and PG represents a protecting group chosen from the group of substituted methyl, substituted ethyl, (substituted) benzyl and (substituted) silyl groups with at least one substituent on the Si-atom being not a methyl group, in case m=1; and a diol protecting group in case m=2 in the presence of a metal-based catalyst bearing ligands.

12. Process according to claim 11, wherein the difference in molecular weight of the two olefins preferably is such that the desired product of formula (1) contains at least 5C more or 5C less than the side-product resulting from the homo coupling of the olefin used in excess.

13. Process according to claim 6, wherein first the protected unsaturated alcohol with formula (1) is prepared according to claim 6 and subsequently the protected unsaturated alcohol is subjected to reduction and deprotection.
